(19) United States
(12) Patent Application Publication
(10) Pub. No.: US 2020/0130521 A1
(43) Pub. Date: Apr. 30, 2020

(54) POWER CONVERSION CABLE APPARATUS

(71) Applicant: Toyota Jidosha Kabushiki Kaisha, Toyota-shi (JP)

(72) Inventor: Shinji Ichikawa, Toyota-shi (JP)

(21) Appl. No.: 16/662,871

(22) Filed: Oct. 24, 2019

(30) Foreign Application Priority Data
Oct. 29, 2018 (JP) 2018-202863

(51) Int. Cl. B60L 53/18; H02M 3/335; H02M 1/42; H02J 7/02; B60L 53/16; B60L 3/00

(52) U.S. Cl. CPC B60L 53/18; H02M 3/33569; H02M 1/4225; H02M 2001/0009; B60L 53/16; B60L 3/00; H02J 7/022

(57) ABSTRACT

A power conversion cable apparatus includes: a plug having a terminal connectable to an AC outlet; a DC connector having a terminal connectable to a DC inlet of a vehicle; a cable connecting the plug and the DC connector; an abnormality detection module; and an AC/DC conversion circuit. The abnormality detection module is configured to detect an abnormality of a current at a detection spot. The AC/DC conversion circuit is located on the terminal side relative to the detection spot and configured to convert AC power input from the terminal side into DC power and output the DC power to the terminal side.

### CROSS REFERENCE TO RELATED APPLICATIONS

This nonprovisional application claims priority to Japanese Patent Application No. 2018-202863 filed on Oct. 29, 2018 with the Japan Patent Office, the entire contents of which are hereby incorporated by reference.

### BACKGROUND

### Field

The present disclosure relates to a power conversion cable apparatus.

### Description of the Background Art

In recent years, from the perspective of environmental conservation, electrically powered vehicles (e.g., electric vehicles or plug-in hybrid vehicles) powered mainly by electric power tend to increase. Such vehicles include an inlet configured to receive electric power supplied from a power feeding facility, and charge a vehicle-mounted battery with the electric power received by the inlet. When a connector of a charging cable of the power feeding facility is connected to the inlet of the vehicle, electric power can be supplied from the power feeding facility through the charging cable to the inlet of the vehicle.

An AC power supply method (hereinafter, also referred to as “AC method”) and a DC power supply method (hereinafter, also referred to as “DC method”) are known as main power feeding methods. A normal charger and a quick charger are known as main power feeding facilities. The AC method is used in the normal charger, and the DC method is used in the quick charger. An electrical outlet-type normal charger includes an electrical outlet for AC power (hereinafter, also referred to as “AC outlet”). A charging cable including a plug at one end and a connector at the other end is used in the electrical outlet-type normal charger. The plug of the charging cable is connected to the AC outlet of the normal charger, and the connector of the charging cable is connected to an inlet for AC power (hereinafter, also referred to as “AC inlet”) of a vehicle.

The vehicle-mounted battery can also be charged with electric power output from a household AC outlet. For example, Japanese Patent Laying-Open No. 2010-110055 discloses a charging cable including a plug connectable to a household AC outlet (more particularly, an electrical outlet of single-phase AC 100 V provided on an outer wall of a house).

### SUMMARY

A connector of the charging cable described in Japanese Patent Laying-Open No. 2010-110055 above is connected to an AC inlet of a vehicle. Therefore, the charging cable described in Japanese Patent Laying-Open No. 2010-110055 cannot be used in a vehicle that does not include an AC inlet. However, the widespread use of a vehicle including only an inlet for DC power (hereinafter, also referred to as “DC inlet”) is expected in the future. Hereinafter, a vehicle including only a DC inlet will be referred to as “DC dedicated vehicle”. Generally, a power feeding facility adapted to the DC method is large and is difficult to be placed in a house. Therefore, it is required to prepare, for the above-described future, a new tool for the DC dedicated vehicle to be supplied with electric power from the AC outlet.

The present disclosure has been made to solve the above-described problem, and an object of the present disclosure is to provide a power conversion cable apparatus that allows a vehicle including only a DC inlet to be supplied with electric power from an AC outlet and is capable of detecting an abnormality of a current during electric power supply.

A power conversion cable apparatus according to the present disclosure includes: a plug having an AC terminal connectable to an electrical outlet for AC power (AC outlet); a DC connector having a DC terminal connectable to an inlet for DC power of a vehicle; a cable connecting the plug and the DC connector; an abnormality detector; and a power conversion circuit. The abnormality detector is configured to detect an abnormality of a current at a detection spot between the AC terminal and the DC terminal. The power conversion circuit is located on the DC terminal side relative to the detection spot and configured to convert AC power input from the AC terminal side into DC power and output the DC power to the DC terminal side.

The above-described power conversion cable apparatus can receive the AC power output from the AC outlet at the plug. Then, the AC power received at the plug can be converted into the DC power by the above-described power conversion circuit. In addition, the DC connector is configured to be connectable to the DC inlet of the vehicle. Therefore, by using the above-described power conversion cable apparatus, a vehicle including only a DC inlet can be supplied with electric power from the AC outlet. The power conversion cable apparatus can convert the AC power output from the AC outlet into the DC power and supply the DC power to the vehicle. Furthermore, the above-described abnormality detector in the power conversion cable apparatus can detect the abnormality of the current during electric power supply.

Since the AC outlet outputs electric power supplied from a power supply, the plug side corresponds to the upstream side (side close to the power supply) and the DC connector side corresponds to the downstream side (side distant from the power supply) in the above-described power conversion cable apparatus. The abnormality detector detects the abnormality of the current downstream of the detection spot. For example, the abnormality detector can detect the abnormality of the current based on a state of the current returning from the downstream side to the upstream side. In the above-described power conversion cable apparatus, the detection spot of the abnormality detector is located upstream (on the plug side) of the power conversion circuit, and thus, the abnormality detector can detect the abnormality of the current in a wide range.

In the above-described power conversion cable apparatus, the abnormality detector may include: a current sensor configured to detect the current at the detection spot; a switch configured to switch conduction and cut-off of a current between the AC terminal and the power conversion circuit; and a controller configured to control the switch. The controller may be configured to bring the switch into an open state, when it is determined, using a result of detection by the current sensor, that the current at the detection spot has the abnormality.

According to the above-described power conversion cable apparatus, when the abnormality of the current occurs during electric power supply to the vehicle, for example, the current is cut off by the switch. As a result, a circuit on the power reception side (e.g., an electronic circuit of the vehicle) can be appropriately protected. In the above-described power conversion cable apparatus, the abnormality detector may be housed in a housing of the plug. The power conversion circuit may be housed in a housing of the DC connector.

If an intermediate part of the cable is heavy in use of the power conversion cable apparatus, the power conversion cable apparatus tends to be cumbersome. In this respect, in the above-described power conversion cable apparatus, the abnormality detector and the power conversion circuit are provided in portions (the plug and the DC connector) other than the cable. Therefore, the cumbersomeness of the power conversion cable apparatus caused by addition of the abnormality detector and the power conversion circuit can be reduced.

In the above-described power conversion cable apparatus, the abnormality detector and the power conversion circuit may be housed in a housing of the plug.

In the above-described power conversion cable apparatus, the abnormality detector and the power conversion circuit are arranged in the single housing. Therefore, by providing one power supply (i.e., a power supply common to the abnormality detector and the power conversion circuit) in the housing, electric power for driving the abnormality detector and the power conversion circuit can be ensured. In addition, in the above-described power conversion cable apparatus, the abnormality detector and the power conversion circuit are housed in the housing of the plug. Therefore, the AC terminal is close to the abnormality detector and the power conversion circuit. Thus, in such a configuration that the electric power for driving the abnormality detector and the power conversion circuit is ensured from the electric power input from the AC outlet to the AC terminal, a wiring for drawing the electric power into the abnormality detector and the power conversion circuit can be simplified.

In the above-described power conversion cable apparatus, the abnormality detector and the power conversion circuit may be housed in a housing of the DC connector.

In the above-described power conversion cable apparatus, the abnormality detector and the power conversion circuit are housed in the housing of the DC connector, and thus, the plug is easily reduced in size. Since the plug of the power conversion cable apparatus can be reduced in size, the power conversion cable apparatus can be adapted to many AC outlets (and further, various infrastructures).

In the above-described power conversion cable apparatus, a housing configured to house the abnormality detector and the power conversion circuit may be provided partway along the cable.

In the above-described power conversion cable apparatus, the abnormality detector and the power conversion circuit are provided in portions (partway along the cable) other than the plug and the DC connector. Therefore, as the plug and the DC connector, an existing plug (e.g., a plug used in a general charging cable adapted to the AC method) and an existing DC connector (e.g., a connector used in a general charging cable adapted to the DC method) can be used as they are. The use of the existing components leads to reduction in cost.

In the above-described power conversion cable apparatus, the abnormality detector may be housed in a housing of the plug. A housing configured to house the power conversion circuit may be provided partway along the cable.

In the above-described power conversion cable apparatus, the abnormality detector and the power conversion circuit are provided in portions other than the DC connector. Therefore, as the DC connector, an existing DC connector (e.g., a connector used in a general charging cable adapted to the DC method) can be used as it is. The use of the existing component leads to reduction in cost. In addition, since the abnormality detector is mounted in the plug and the power conversion circuit is mounted partway along the cable, an excessive increase in size of one of the plug and an intermediate part of the cable can be inhibited.

In the above-described power conversion cable apparatus, a housing configured to house the abnormality detector may be provided partway along the cable. The power conversion circuit may be housed in a housing of the DC connector.

The above-described housing (housing that houses the abnormality detector) provided partway along the cable can be implemented by a CCID (Charging Circuit Interrupt Device) box used in a general charging cable adapted to the AC method. In addition, as the plug, an existing plug (e.g., a plug used in a general charging cable adapted to the AC method) can be used as it is. The use of the existing components as described above leads to reduction in cost.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 shows an appearance of a power conversion cable apparatus according to a first embodiment of the present disclosure.

FIG. 2 is a figure for illustrating an internal configuration of the power conversion cable apparatus according to the first embodiment.

FIG. 3 shows details of an AC/DC conversion circuit shown in FIG. 2.

FIG. 4 is a figure for illustrating an internal configuration of a power conversion cable apparatus according to a second embodiment.

FIG. 5 is a figure for illustrating an internal configuration of a power conversion cable apparatus according to a third embodiment.

FIG. 6 shows an appearance of a power conversion cable apparatus according to a fourth embodiment of the present disclosure.

FIG. 7 is a figure for illustrating an internal configuration of the power conversion cable apparatus according to the fourth embodiment.

FIG. 8 is a figure for illustrating an internal configuration of a power conversion cable apparatus according to a fifth embodiment.

FIG. 9 is a figure for illustrating an internal configuration of a power conversion cable apparatus according to a sixth embodiment.

### DETAILED DESCRIPTION

Embodiments of the present disclosure will be described in detail with reference to the drawings, in which the same or corresponding portions are denoted by the same reference characters and description thereof will not be repeated.

### First Embodiment

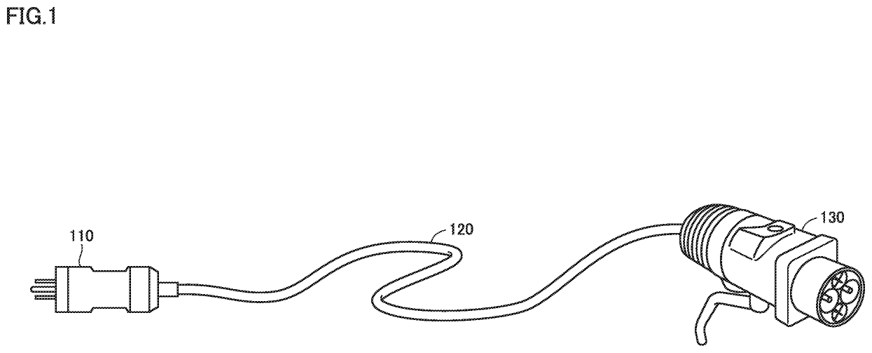

FIG. 1 shows an appearance of a power conversion cable apparatus according to a first embodiment of the present disclosure. Referring to FIG. 1, the power conversion cable apparatus according to the present embodiment includes a plug 110, a DC connector 130, and a cable 120 connecting plug 110 and DC connector 130. A known flexible cable used in a general charging cable can be used as cable 120.

Plug 110 is configured to be connectable to an electrical outlet for AC power (AC outlet). Examples of the AC outlet include an AC outlet of a normal charger or a household AC outlet. The household AC outlet is connected to a system power supply with a wiring breaker being interposed. The system power supply is an AC power supply (e.g., a single-phase AC power supply having a voltage of 100 V or 200 V) supplied with electric power from a power grid (e.g., a power grid provided by a power company).

DC connector 130 is configured to be connectable to an inlet for DC power (DC inlet) of a vehicle. Examples of the DC inlet of the vehicle include DC inlets adapted to various types of power feeding methods (such as a CHAdeMO method, a CCS (Combined Charging System) method and a GB/T method).

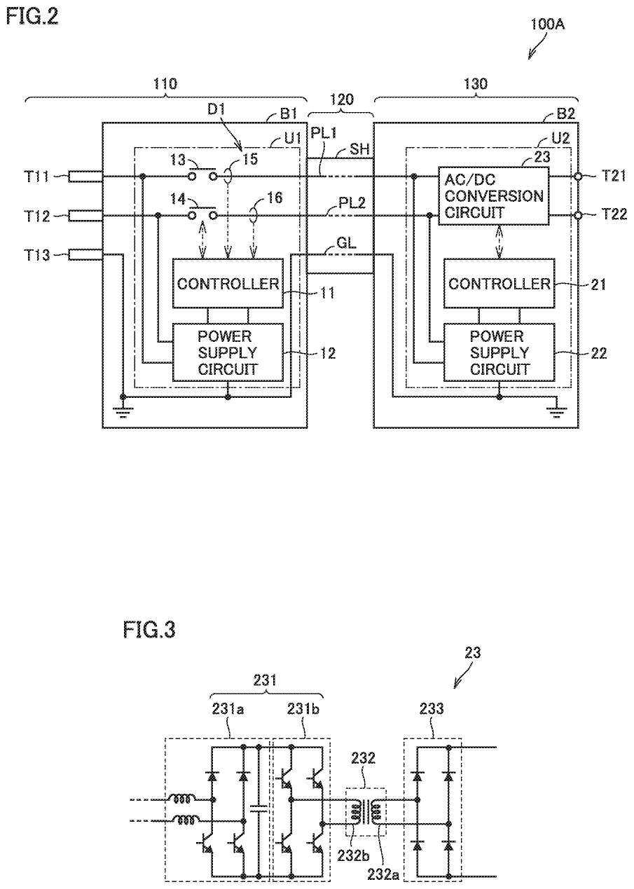

FIG. 2 is a figure for illustrating an internal configuration of a power conversion cable apparatus 100A according to the first embodiment.

Referring to FIG. 2, plug 110 has a housing B1 and an abnormality detection module U1 is housed in housing B1. Plug 110 further has terminals T11 to T13. Terminals T11 to T13 are exposed to a surface of housing B1. When plug 110 is inserted into the AC outlet, terminals T11, T12 and T13 of plug 110 are electrically connected to a HOT terminal, a COLD terminal and a ground terminal of the AC outlet (and further, the AC power supply), respectively. Terminals T11 and T12 are connected to power lines PL1 and PL2 in housing B1, respectively, and terminal T13 is connected to a ground line GL in housing B1. Terminals T11 and T12 according to the present embodiment correspond to one example of “AC terminal” according to the present disclosure.

Cable 120 has a sheath (outer cover) SH, and power lines PL1 and PL2 and ground line GL are housed in sheath SH. Power lines PL1 and PL2 and ground line GL are routed to extend over plug 110, cable 120 and DC connector 130.

DC connector 130 has a housing B2 and a power conversion module U2 is housed in housing B2. DC connector 130 further has terminals T21 and T22. Terminals T21 and T22 are exposed to a surface of housing B2. When DC connector 130 is connected to the DC inlet of the vehicle, terminals T21 and T22 of DC connector 130 are electrically connected to corresponding terminals of the DC inlet of the vehicle, respectively. As a result, electric power output to terminals T21 and T22 can be supplied to the vehicle (and further, a vehicle-mounted battery). Terminals T21 and T22 correspond to a P (positive) terminal and an N (negative) terminal, respectively, and are connected to power lines PL1 and PL2 in housing B2, respectively. Terminals T21 and T22 according to the present embodiment correspond to one example of “DC terminal” according to the present disclosure.

Abnormality detection module U1 includes a controller 11 and a power supply circuit 12, and power conversion module U2 includes a controller 21 and a power supply circuit 22. Power supply circuits 12 and 22 are configured to supply driving power (i.e., electric power for operating the controllers) to controllers 11 and 21, respectively.

Each of controllers 11 and 21 includes a processor, a memory device and an input/output port (all are not shown). A CPU (Central Processing Unit) can, for example, be used as the processor. The memory device includes a RAM (Random Access Memory) configured to temporarily store data, and a storage (e.g., a ROM (Read Only Memory) and a rewritable nonvolatile memory) configured to save various types of information. In addition to programs used in various types of control, various parameters used in the programs are also prestored in the storage. The processor executes the programs stored in the memory device and the various types of control are thereby performed. The various types of control can be processed not only by software but also by dedicated hardware (electronic circuit).

Power supply circuits 12 and 22 are configured to generate the driving power of controllers 11 and 21 using AC power supplied from power lines PL1 and PL2, and supply the generated driving power to controllers 11 and 21, respectively. For example, each of power supply circuits 12 and 22 includes an AC/DC conversion circuit. Power supply circuits 12 and 22 are configured to convert the AC power supplied from power lines PL1 and PL2 into DC power suitable for driving of controllers 11 and 21, respectively.

Abnormality detection module U1 further includes switches 13 and 14, and current sensors 15 and 16, in addition to controller 11 and power supply circuit 12. Abnormality detection module U1 according to the present embodiment corresponds to one example of “abnormality detector” according to the present disclosure.

Switches 13 and 14 are provided in power lines PL1 and PL2, respectively. Switches 13 and 14 are configured to switch conduction and cut-off of a current between terminals T11 and T12 of plug 110 and an AC/DC conversion circuit 23 in housing B2 of DC connector 130. A state (closed state (conducting state)/open state (cut-off state)) of switches 13 and 14 is controlled by controller 11. An electromagnetic mechanical relay can, for example, be used as switches 13 and 14. However, a semiconductor relay that is also referred to as “SSR (Solid State Relay)” may be used as switches 13 and 14. Examples of the semiconductor relay include a relay formed of a thyristor, a triac or a transistor (such as an IGBT, a MOSFET or a bipolar transistor).

Current sensors 15 and 16 are configured to detect a current flowing through power lines PL1 and PL2, respectively. Current sensors 15 and 16 are provided at a prescribed detection spot D1 and configured to detect the current at detection spot D1. In the present embodiment, detection spot D1 is set in the vicinity of switches 13 and 14 (more particularly, on the terminals T21 and T22 side relative to switches 13 and 14) in housing B1.

Power conversion module U2 further includes AC/DC conversion circuit 23, in addition to controller 21 and power supply circuit 22. AC/DC conversion circuit 23 is located on the terminals T21 and T22 side relative to current sensors 15 and 16 (and further, detection spot D1). AC/DC conversion circuit 23 according to the present embodiment corresponds to one example of “power conversion circuit” according to the present disclosure.

FIG. 3 shows details of AC/DC conversion circuit 23. Referring to FIG. 3, AC/DC conversion circuit 23 includes a power factor correction (PFC) circuit 231, an insulating circuit 232 and a rectifier circuit 233. PFC circuit 231 includes a rectifier circuit 231a and an inverter 231b. Insulating circuit 232 is an insulating transformer including a first coil 232a and a second coil 232b.

Rectifier circuit 231a is configured to rectify and boost the input AC power. More specifically, rectifier circuit 231a includes two pairs of upper and lower arms, two reactors and one smoothing capacitor. In each pair of upper and lower arms, the upper arm includes a diode and the lower arm includes a switching element. The switching element of the lower arm is controlled by controller 21. Each switching element included in rectifier circuit 231a is controlled by controller 21, and thus, rectifier circuit 231a functions as a boosting chopper circuit.

Inverter 231b is a full-bridge circuit including four switching elements. Each switching element is controlled by controller 21. Each switching element included in inverter 231b is controlled by controller 21 and the DC power input from rectifier circuit 231a to inverter 231b is thereby converted into high-frequency AC power.

In insulating circuit 232, second coil 232b is located on the terminals T11 and T12 side (PFC circuit 231 side) relative to first coil 232a. Rectifier circuit 233 is connected to first coil 232a of insulating circuit 232 through an electric line, and PFC circuit 231 is connected to second coil 232b of insulating circuit 232 through an electric line.

First coil 232a and second coil 232b are electrically insulated from each other. An electric power path on the terminals T11 and T12 side (PFC circuit 231 side) relative to second coil 232b and an electric power path on the terminals T21 and T22 side (rectifier circuit 233 side) relative to first coil 232a are electrically insulated from each other by insulating circuit 232. Insulating circuit 232 boosts an AC voltage applied to second coil 232b and outputs the boosted AC voltage to first coil 232a.

Rectifier circuit 233 is a diode bridge circuit including four diodes. Rectifier circuit 233 is configured to convert the AC power supplied from first coil 232a of insulating circuit 232 into DC power.

Referring again to FIG. 2, AC/DC conversion circuit 23 is configured as described above (see FIG. 3), and thus, is configured to perform AC/DC conversion (conversion from AC to DC) of the AC power input from the terminals T11 and T12 side and output DC power to the terminals T21 and T22 side. The configuration of AC/DC conversion circuit 23 is not limited to the configuration shown in FIG. 3. For example, AC/DC conversion circuit 23 may be a rectifier circuit that does not include an insulating circuit.

In abnormality detection module U1, controller 11 determines whether or not the current at detection spot D1 has an abnormality, using a result of detection by current sensors 15 and 16. In power conversion cable apparatus 100A, the terminals T11 and T12 side corresponds to the upstream side (side close to the power supply), and the terminals T21 and T22 side corresponds to the downstream side (side distant from the power supply). The above-described result of detection by current sensors 15 and 16 tends to indicate the abnormality of the current downstream of detection spot D1. For example, controller 11 may determine that the abnormality of the current (more particularly, electric leakage) occurs, when an equilibrium state of the current flowing through detection spot D1 is broken. Controller 11 may also determine that the abnormality of the current (more particularly, overcurrent) occurs, when an excessive current is detected at detection spot D1. In power conversion cable apparatus 100A according to the present embodiment, detection spot D1 is located in housing B1 of plug 110 (i.e., upstream of AC/DC conversion circuit 23), and thus, the abnormality of the current can be detected in a wide range including cable 120 and DC connector 130.

In abnormality detection module U1, controller 11 is configured to bring switches 13 and 14 into the open state, when it is determined, using the result of detection by current sensors 15 and 16, that the current at detection spot D1 has the abnormality. Therefore, when the abnormality of the current occurs during electric power supply to the vehicle, for example, the current is cut off by switches 13 and 14. As a result, a circuit on the power reception side (e.g., an electronic circuit of the vehicle) can be appropriately protected.

As described above, power conversion cable apparatus 100A according to the present embodiment can receive the AC power output from the AC outlet at plug 110. Then, the AC power received at plug 110 can be converted into DC power by AC/DC conversion circuit 23. In addition, DC connector 130 is configured to be connectable to the DC inlet of the vehicle. Therefore, by using above-described power conversion cable apparatus 100A, a vehicle including only a DC inlet (DC dedicated vehicle) can be supplied with electric power from the AC outlet. Power conversion cable apparatus 100A can convert the AC power output from the AC outlet into DC power and supply the DC power to the vehicle. In addition, above-described abnormality detection module U1 in power conversion cable apparatus 100A can detect the abnormality of the current during electric power supply.

Abnormality detection module U1 is housed in housing B1 of plug 110. Power conversion module U2 (and further, AC/DC conversion circuit 23) is housed in housing B2 of DC connector 130.

If an intermediate part of cable 120 is heavy in use of power conversion cable apparatus 100A, power conversion cable apparatus 100A tends to be cumbersome. More specifically, if the intermediate part of cable 120 is heavy, it is difficult to carry power conversion cable apparatus 100A or connect DC connector 130 to the DC inlet of the vehicle. In power conversion cable apparatus 100A according to the present embodiment, abnormality detection module U1 and power conversion module U2 are not provided in cable 120. Therefore, the cumbersomeness of power conversion cable apparatus 100A caused by addition of abnormality detection module U1 and power conversion module U2 can be reduced.

Generally, the DC inlet of the vehicle tends to be arranged at a position higher than that of the AC outlet. In power conversion cable apparatus 100A according to the present embodiment, AC/DC conversion circuit 23 is housed in housing B2 of DC connector 130, and thus, AC/DC conversion circuit 23 is less likely to be submerged in water. Since a circuit configuration of abnormality detection module U1 is simplified more easily than that of AC/DC conversion circuit 23, abnormality detection module U1 tends to be more excellent in water resistance than AC/DC conversion circuit 23.

### Second Embodiment

A power conversion cable apparatus according to a second embodiment of the present disclosure will be described. Since the second embodiment has many features common to those of the first embodiment, differences will be mainly described and description of the common features will not be repeated.

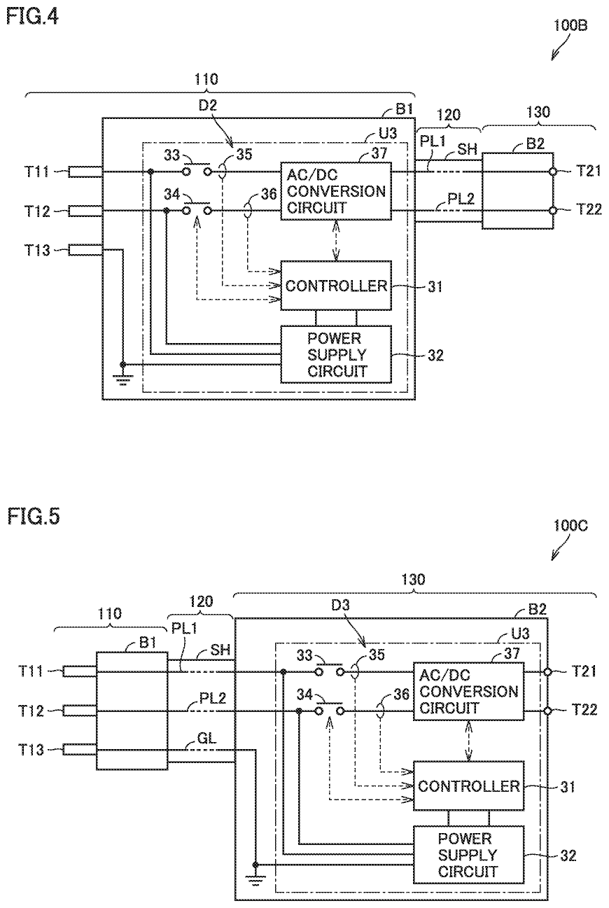

The power conversion cable apparatus according to the second embodiment also has the configuration shown in FIG. 1 in appearance. However, an internal configuration of the power conversion cable apparatus according to the second embodiment is different from that of the first embodiment. FIG. 4 is a figure for illustrating an internal configuration of a power conversion cable apparatus 100B according to the second embodiment.

Referring to FIG. 4, power conversion cable apparatus 100B includes plug 110, cable 120 and DC connector 130. Plug 110 has housing B1. In the present embodiment, an integrated module U3 is housed in housing B1, instead of abnormality detection module U1 (FIG. 2). Power conversion module U2 (FIG. 2) is not housed in housing B2 of DC connector 130. Cable 120 has sheath SH and power lines PL1 and PL2 are housed in sheath SH. Power lines PL1 and PL2 are routed to extend over plug 110, cable 120 and DC connector 130.

Integrated module U3 includes a controller 31 and a power supply circuit 32. Controller 31 has the same hardware configuration as that of controllers 11 and 21 in the first embodiment. That is, controller 31 also includes a processor and a memory device (both are not shown). Power supply circuit 32 is configured to generate driving power of controller 31 using AC power supplied from power lines PL1 and PL2, and supply the generated driving power to controller 31. For example, power supply circuit 32 includes an AC/DC conversion circuit. Power supply circuit 32 is configured to convert the AC power supplied from power lines PL1 and PL2 into DC power suitable for driving of controller 31.

Integrated module U3 further includes switches 33 and 34, current sensors 35 and 36, and AC/DC conversion circuit 37, in addition to controller 31 and power supply circuit 32. A state (closed state (conducting state)/open state (cut-off state)) of switches 33 and 34 is controlled by controller 31. Switches similar to above-described switches 13 and 14 (FIG. 2) can be used as switches 33 and 34. In addition, a circuit similar to above-described AC/DC conversion circuit 23 (e.g., see FIG. 3) can be used as AC/DC conversion circuit 37.

Switches 33 and 34 are provided in power lines PL1 and PL2, respectively. Switches 33 and 34 are configured to switch conduction and cut-off of a current between terminals T11 and T12 and AC/DC conversion circuit 37. Current sensors 35 and 36 are configured to detect a current flowing through power lines PL1 and PL2, respectively. Current sensors 35 and 36 are provided at a prescribed detection spot D2 and configured to detect the current at detection spot D2. In the present embodiment, detection spot D2 is set in the vicinity of switches 33 and 34 (more particularly, between switches 33 and 34 and AC/DC conversion circuit 37) in housing B1. AC/DC conversion circuit 37 is located on the terminals T21 and T22 side relative to current sensors 35 and 36 (and further, detection spot D2) and configured to convert AC power input from the terminals T11 and T12 side into DC power and output the DC power to the terminals T21 and T22 side.

In integrated module U3, controller 31 is configured to detect an abnormality of the current at detection spot D2, using a result of detection by current sensors 35 and 36. In addition, controller 31 is configured to bring switches 33 and 34 into the open state, when it is determined, using the result of detection by current sensors 35 and 36, that the current at detection spot D2 has the abnormality (e.g., electric leakage or overcurrent). Therefore, when the abnormality of the current occurs during electric power supply to the vehicle, for example, the current is cut off by switches 33 and 34. As a result, a circuit on the power reception side (e.g., an electronic circuit of the vehicle) can be appropriately protected.

Controller 31, switches 33 and 34, and current sensors 35 and 36 according to the present embodiment form one example of “abnormality detector” according to the present disclosure. AC/DC conversion circuit 37 according to the present embodiment corresponds to one example of “power conversion circuit” according to the present disclosure. That is, integrated module U3 according to the present embodiment includes both “abnormality detector” and “power conversion circuit” according to the present disclosure.

As described above, power conversion cable apparatus 100B according to the present embodiment can convert the AC power output from the AC outlet into DC power and supply the DC power to the vehicle. In addition, above-described integrated module U3 can detect the abnormality of the current during electric power supply.

Furthermore, in power conversion cable apparatus 100B, integrated module U3 is housed in housing B1 of plug 110. Therefore, terminals T11 and T12 are close to integrated module U3. Therefore, a wiring for drawing electric power input from the AC outlet to terminals T11 and T12 into integrated module U3 can be simplified.

### Third Embodiment

A power conversion cable apparatus according to a third embodiment of the present disclosure will be described. Since the third embodiment has many features common to those of the second embodiment, differences will be mainly described and description of the common features will not be repeated.

The power conversion cable apparatus according to the third embodiment also has the configuration shown in FIG. 1 in appearance. However, an internal configuration of the power conversion cable apparatus according to the third embodiment is different from that of the second embodiment. FIG. 5 is a figure for illustrating an internal configuration of a power conversion cable apparatus 100C according to the third embodiment.

Referring to FIG. 5, power conversion cable apparatus 100C includes plug 110, cable 120 and DC connector 130. In the present embodiment, integrated module U3 is housed in housing B2 of DC connector 130, not in housing B1 of plug 110.

In integrated module U3 in housing B2, current sensors 35 and 36 are provided at a prescribed detection spot D3 and configured to detect a current at detection spot D3. In the present embodiment, detection spot D3 is set in the vicinity of switches 33 and 34 (more particularly, between switches 33 and 34 and AC/DC conversion circuit 37) in housing B2. Controller 31 is configured to bring switches 33 and 34 into an open state, when it is determined, using a result of detection by current sensors 35 and 36, that the current at detection spot D3 has an abnormality (e.g., electric leakage or overcurrent). AC/DC conversion circuit 37 is located on the terminals T21 and T22 side relative to detection spot D3 and configured to convert AC power input from the terminals T11 and T12 side into DC power and output the DC power to the terminals T21 and T22 side.

A system power supply is often used as a general AC outlet and many AC outlets are prepared as infrastructures. Therefore, plug 110 connected to the AC outlet tends to be subjected to stricter restrictions about size and shape than DC connector 130. In this respect, in power conversion cable apparatus 100C according to the present embodiment, integrated module U3 is housed in housing B2 of DC connector 130. Therefore, plug 110 can be reduced in size. Since plug 110 of power conversion cable apparatus 100C can be reduced in size, power conversion cable apparatus 100C can be adapted to many AC outlets (and further, various infrastructures).

### Fourth Embodiment

A power conversion cable apparatus according to a fourth embodiment of the present disclosure will be described. Since the fourth embodiment has many features common to those of the second embodiment, differences will be mainly described and description of the common features will not be repeated.

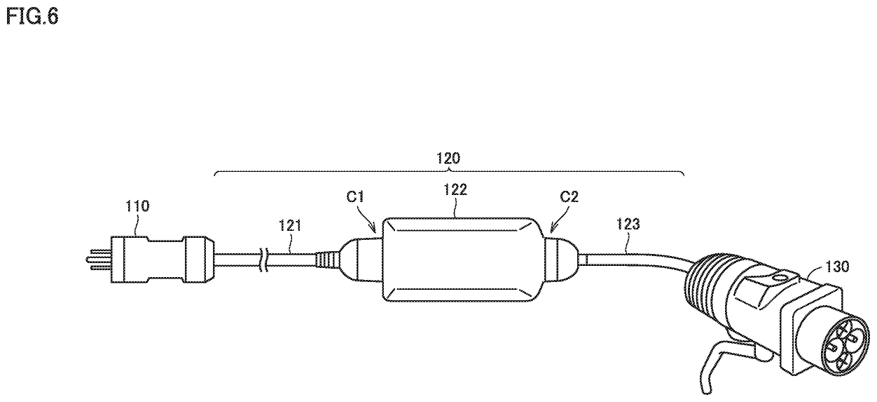

FIG. 6 shows an appearance of the power conversion cable apparatus according to the fourth embodiment of the present disclosure. Referring to FIG. 6, the power conversion cable apparatus according to the present embodiment includes plug 110, DC connector 130, and cable 120 connecting plug 110 and DC connector 130. However, cable 120 includes an AC-side cable 121, a control box 122 and a DC-side cable 123. A known flexible cable used in a general charging cable can be used as each of AC-side cable 121 and DC-side cable 123. AC-side cable 121 and control box 122 are connected to each other by a connection portion C1, and control box 122 and DC-side cable 123 are connected to each other by a connection portion C2. Connection portions C1 and C2 may be detachable, or may be integrated (not detachable).

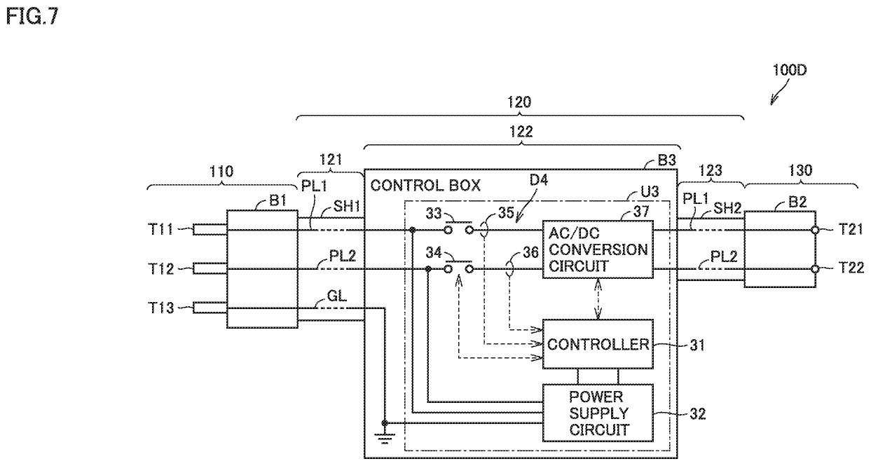

FIG. 7 is a figure for illustrating an internal configuration of a power conversion cable apparatus 100D according to the fourth embodiment.

Referring to FIG. 7, power conversion cable apparatus 100D includes plug 110, AC-side cable 121, control box 122, DC-side cable 123, and DC connector 130. Control box 122 has a housing B3. In the present embodiment, integrated module U3 is housed in housing B3 of control box 122, not in housing B1 of control box 122. AC-side cable 121 has a sheath SH1, and power lines PL1 and PL2 and ground line GL are housed in sheath SH1. DC-side cable 123 has a sheath SH2, and power lines PL1 and PL2 are housed in sheath SH2. Power lines PL1 and PL2 are routed to extend over plug 110, cable 120 and DC connector 130.

In integrated module U3 in housing B3, current sensors 35 and 36 are provided at a prescribed detection spot D4 and configured to detect a current at detection spot D4. In the present embodiment, detection spot D4 is set in the vicinity of switches 33 and 34 (more particularly, between switches 33 and 34 and AC/DC conversion circuit 37) in housing B3. Controller 31 is configured to bring switches 33 and 34 into an open state, when it is determined, using a result of detection by current sensors 35 and 36, that the current at detection spot D4 has an abnormality (e.g., electric leakage or overcurrent). AC/DC conversion circuit 37 is located on the terminals T21 and T22 side relative to detection spot D4 and configured to convert AC power input from the terminals T11 and T12 side into DC power and output the DC power to the terminals T21 and T22 side.

In power conversion cable apparatus 100D according to the present embodiment, control box 122 is provided partway along cable 120 and integrated module U3 is housed in housing B3 of control box 122. Therefore, as plug 110 and DC connector 130, an existing plug (e.g., a plug used in a general charging cable adapted to the AC method) and an existing DC connector (e.g., a connector used in a general charging cable adapted to the DC method) can be used as they are. The use of the existing components leads to reduction in cost.

Control box 122 in power conversion cable apparatus 100D may be configured to be wall-mountable. For example, housing B3 of control box 122 has a structure for attaching a wall-mounted bracket. By making control box 122 wall-mountable, power conversion cable apparatus 100D becomes easy to handle. In addition, stress of power conversion cable apparatus 100D due to a weight of control box 122 can be reduced.

### Fifth Embodiment

A power conversion cable apparatus according to a fifth embodiment of the present disclosure will be described. Since the fifth embodiment has many features common to those of the fourth embodiment, differences will be mainly described and description of the common features will not be repeated.

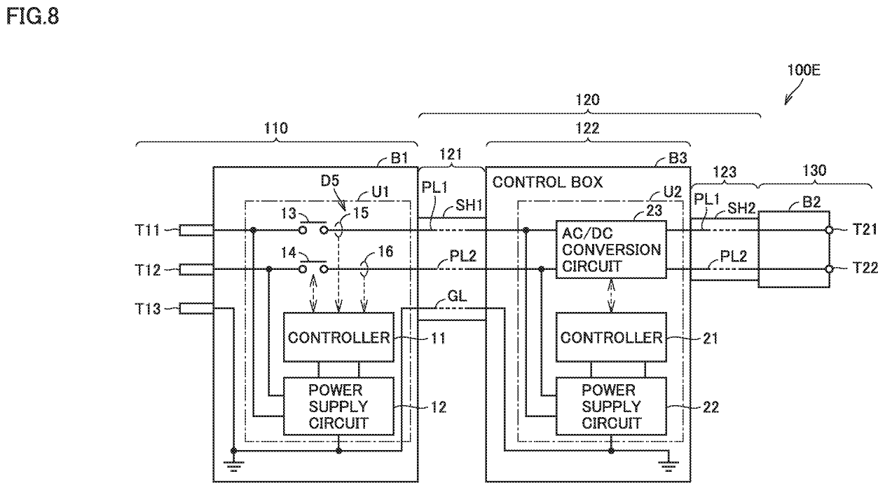

The power conversion cable apparatus according to the fifth embodiment also has the configuration shown in FIG. 6 in appearance. However, an internal configuration of the power conversion cable apparatus according to the fifth embodiment is different from that of the fourth embodiment. FIG. 8 is a figure for illustrating an internal configuration of a power conversion cable apparatus 100E according to the fifth embodiment.

Referring to FIG. 8, power conversion cable apparatus 100E includes plug 110, AC-side cable 121, control box 122, DC-side cable 123, and DC connector 130. In the present embodiment, abnormality detection module U1 and power conversion module U2 are used, instead of integrated module U3. Abnormality detection module U1 is housed in housing B1 of plug 110, and power conversion module U2 is housed in housing B3 of control box 122. The configuration of abnormality detection module U1 and power conversion module U2 are the same as that of the first embodiment (see FIG. 2).

In abnormality detection module U1 in housing B1, current sensors 15 and 16 are provided at a prescribed detection spot D5 and configured to detect a current at detection spot D5. In the present embodiment, detection spot D5 is set in the vicinity of switches 13 and 14 (more particularly, on the terminals T21 and T22 side relative to switches 13 and 14) in housing B1. Controller 11 is configured to bring switches 13 and 14 into an open state, when it is determined, using a result of detection by current sensors 15 and 16, that the current at detection spot D5 has an abnormality (e.g., electric leakage or overcurrent). In addition, in power conversion module U2 in housing B3, AC/DC conversion circuit 23 is located on the terminals T21 and T22 side relative to detection spot D5 and configured to convert AC power input from the terminals T11 and T12 side into DC power and output the DC power to the terminals T21 and T22 side.

In power conversion cable apparatus 100E according to the present embodiment, abnormality detection module U1 is housed in housing B1 of plug 110. In addition, control box 122 is provided partway along cable 120 and power conversion module U2 (and further, AC/DC conversion circuit 23) is housed in housing B3 of control box 122. Therefore, as DC connector 130, an existing DC connector (e.g., a connector used in a general charging cable adapted to the DC method) can be used as it is. The use of the existing component leads to reduction in cost. In addition, since abnormality detection module U1 is mounted in plug 110 and power conversion module U2 is mounted in control box 122, an excessive increase in size of one of plug 110 and control box 122 can be inhibited.

### Sixth Embodiment

A power conversion cable apparatus according to a sixth embodiment of the present disclosure will be described. Since the sixth embodiment has many features common to those of the fifth embodiment, differences will be mainly described and description of the common features will not be repeated.

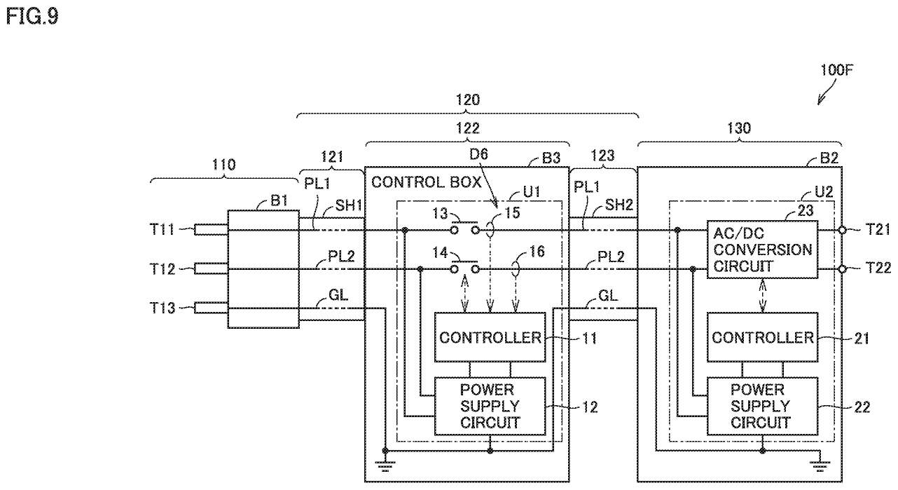

The power conversion cable apparatus according to the sixth embodiment also has the configuration shown in FIG. 6 in appearance. However, an internal configuration of the power conversion cable apparatus according to the sixth embodiment is different from that of the fifth embodiment. FIG. 9 is a figure for illustrating an internal configuration of a power conversion cable apparatus 100F according to the sixth embodiment.

Referring to FIG. 9, power conversion cable apparatus 100F includes plug 110, AC-side cable 121, control box 122, DC-side cable 123, and DC connector 130. In the present embodiment, abnormality detection module U1 is housed in housing B3 of control box 122, and power conversion module U2 is housed in housing B2 of DC connector 130. Power lines PL1 and PL2 and ground line GL are housed in both sheath SH1 of AC-side cable 121 and sheath SH2 of DC-side cable 123. Power lines PL1 and PL2 and ground line GL are routed to extend over plug 110, cable 120 and DC connector 130.

In abnormality detection module U1 in housing B3, current sensors 15 and 16 are provided at a prescribed detection spot D6 and configured to detect a current at detection spot D6. In the present embodiment, detection spot D6 is set in the vicinity of switches 13 and 14 (more particularly, on the terminals T21 and T22 side relative to switches 13 and 14) in housing B3. Controller 11 is configured to bring switches 13 and 14 into an open state, when it is determined, using a result of detection by current sensors 15 and 16, that the current at detection spot D6 has an abnormality (e.g., electric leakage or overcurrent). In addition, in power conversion module U2 in housing B2, AC/DC conversion circuit 23 is located on the terminals T21 and T22 side relative to detection spot D6 and configured to convert AC power input from the terminals T11 and T12 side into DC power and output the DC power to the terminals T21 and T22 side.

In power conversion cable apparatus 100F according to the present embodiment, power conversion module U2 (and further, AC/DC conversion circuit 23) is housed in housing B2 of DC connector 130. In addition, control box 122 is provided partway along cable 120 and abnormality detection module U1 is housed in housing B3 of control box 122. A plug and a CCID box used in a general charging cable adapted to the AC method can be used as plug 110 and control box 122. The use of the existing components as described above leads to reduction in cost.

Connection portion C2 (FIG. 6) connecting control box 122 and DC-side cable 123 in power conversion cable apparatus 100F may be made detachable and a portion (DC-side cable 123 and DC connector 130) on the DC connector 130 side relative to connection portion C2 may thereby be made as an attachment. As a portion (plug 110, AC-side cable 121 and control box 122) on the plug 110 side relative to connection portion C2, an existing charging cable (e.g., a cable equipped with a CCID box) can be used as it is.

### Other Embodiments

The detection spots (e.g., detection spots D1 to D6) related to detection of the abnormality of the current can be changed as appropriate, as long as the detection spots are located on the DC terminal (e.g., terminals T21 and T22) side relative to the power conversion circuit (e.g., AC/DC conversion circuit 23, 37). For example, the detection spots related to detection of the abnormality of the current may be set on the upstream side relative to switches 13 and 14 (or switches 33 and 34).

In each of the embodiments described above, when the abnormality of the current at the detection spot is detected, the current is cut off by the switch (e.g., switch 13, 14, 33, 34). However, a process after detection of the abnormality is not limited to cut-off of the current.

For example, the power conversion cable apparatus may include a notification device (not shown). Examples of the notification device include a display device, a speaker and a lamp. The power conversion cable apparatus may be configured to provide a notification about occurrence of the abnormality, when the abnormality of the current at the detection spot is detected. Any notification process may be used. The notification may be provided by display (e.g., a character or an image) on the display device, or may be provided by sound (including voice) with the speaker, or may be provided by causing a prescribed lamp to light up (including flash).

The power conversion cable apparatus may also be configured to record occurrence of the abnormality, when the abnormality of the current at the detection spot is detected. For example, the occurrence of the abnormality may be recorded on a recording device by switching a value of a flag of diagnostics (On-Board Diagnostics) in the recording device of the power conversion cable apparatus from zero to one.

In each of the embodiments described above, electric power for driving controller 11, 21, 31 is ensured from the electric power input from the AC outlet to terminals T11 and T12. However, the present disclosure is not limited thereto. A power storage device (e.g., a battery) may be provided in the housing that houses the controller, as a power supply for the controller.

While the embodiments of the present disclosure have been described, it should be understood that the embodiments disclosed herein are illustrative and non-restrictive in every respect. The scope of the present disclosure is defined by the terms of the claims and is intended to include any modifications within the scope and meaning equivalent to the terms of the claims.

What is claimed is:

1. A power conversion cable apparatus comprising:
a plug having an AC terminal connectable to an electrical outlet for AC power;
a DC connector having a DC terminal connectable to an inlet for DC power of a vehicle;
a cable connecting the plug and the DC connector;
an abnormality detector configured to detect an abnormality of a current at a detection spot between the AC terminal and the DC terminal; and
a power conversion circuit located on the DC terminal side relative to the detection spot and configured to convert AC power input from the AC terminal side into DC power and output the DC power to the DC terminal side.

2. The power conversion cable apparatus according to claim 1, wherein
the abnormality detector includes:
a current sensor configured to detect the current at the detection spot;
a switch configured to switch conduction and cut-off of a current between the AC terminal and the power conversion circuit; and
a controller configured to control the switch, and
the controller is configured to bring the switch into an open state, when it is determined, using a result of detection by the current sensor, that the current at the detection spot has the abnormality.

3. The power conversion cable apparatus according to claim 2, wherein
the abnormality detector is housed in a housing of the plug, and
the power conversion circuit is housed in a housing of the DC connector.

4. The power conversion cable apparatus according to claim 2, wherein
the abnormality detector and the power conversion circuit are housed in a housing of the plug.

5. The power conversion cable apparatus according to claim 2, wherein
the abnormality detector and the power conversion circuit are housed in a housing of the DC connector.

6. The power conversion cable apparatus according to claim 2, wherein
a housing configured to house the abnormality detector and the power conversion circuit is provided partway along the cable.

7. The power conversion cable apparatus according to claim 2, wherein
the abnormality detector is housed in a housing of the plug, and
a housing configured to house the power conversion circuit is provided partway along the cable.

8. The power conversion cable apparatus according to claim 2, wherein
a housing configured to house the abnormality detector is provided partway along the cable, and
the power conversion circuit is housed in a housing of the DC connector.
